(19) United States
(12) Patent Application Publication
(10) Pub. No.: US 2011/0305822 A1
(43) Pub. Date: Dec. 15, 2011

(54) METHOD FOR MANUFACTURING ELECTROMECHANICAL TRANSDUCER

(75) Inventors: Yoshihiro Hasegawa, Tama-shi (JP); Chienliu Chang, Menlo Park, CA (US); Yuichi Masaki, Kawasaki-shi (JP)

(73) Assignee: CANON KABUSHIKI KAISHA, Tokyo (JP)

(21) Appl. No.: 13/114,567

(22) Filed: May 24, 2011

(30) Foreign Application Priority Data
Jun. 11, 2010 (JP) 2010-134162

(51) Int. Cl. C25F 3/02; B05D 3/10; B05D 5/12

(52) U.S. Cl. 427/58; 205/668

(57) ABSTRACT

This invention includes energizing an electrode in which the surface facing a cavity is exposed as one electrode for electrolytic etching and the other electrode provided at the outside and contacting an electrolytic etching solution to perform electrolytic etching of a sacrificial layer to form a cavity. Thereafter, a removal agent is introduced from an etching hole to reduce residues of the sacrificial layer due to the electrolytic etching.

### BACKGROUND OF THE INVENTION

1. Field of the Invention

The present invention relates to a method for manufacturing an electromechanical transducer to be used as an ultrasonic transducer or the like.

2. Description of the Related Art

In recent years, capacitive electromechanical transducers produced using a micromachining process have been examined. Usual capacitive electromechanical transducers have a vibration film movably supported while maintaining a gap from a lower electrode and an upper electrode disposed on the vibration film. This is used as a Capacitive-Micromachined-Ultrasound-Transducer (CMUT) or the like, for example. As the CMUT, one that transmits and receives ultrasonic waves using a lightweight vibration film and has excellent broadband characteristics in both liquid and the air is easily obtained. The utilization of the CMUT allows a higher accurate diagnosis than a former medical diagnosis, and thus the CMUT has increasingly drawn attention as a promising technique.

The operation principle of the CMUT will be described. When transmitting ultrasonic waves, a small AC voltage is superimposed on a DC voltage and applied between the lower electrode and the upper electrode. Thus, the vibration film vibrates to generate ultrasonic waves. When receiving ultrasonic waves, the vibration film changes the shape due to the ultrasonic wave, and thus signals are detected based on the changes in capacity between the lower electrode and the upper electrode caused by the changes in the shape. The theoretical sensitivity of a device is in inverse proportion to the square of the gap between the electrodes. In order to produce a high sensitive device, a gap of 100 nm or lower is suitable. In recent years, the gap of the CMUT has been examined to be 2 μm in the case of a large device and 100 nm or lower in the case of a small device.

In contrast, as a method for forming the gap of the capacitive electromechanical transducer, a method including providing a sacrificial layer having a thickness equal to the target electrode gap, forming a vibration film on the sacrificial layer, and then removing the sacrificial layer is generally employed. An example of such a technique is disclosed in U.S. Pat. No. 6,426,582 specification.

As described above, in order to increase the sensitivity, i.e., electromechanical conversion efficiency, it is desirable to narrow the electrode gap. U.S. Pat. No. 6,426,582 has also proposed a method therefor. However, even when the gap between the electrodes can be narrowed, the removal by etching of the sacrificial layer (e.g., containing Si, SiO₂, or metal) becomes difficult when the gap is narrower. This is because when the gap becomes narrower than a given value, the penetration rate of an etchant becomes low, which makes it difficult to supply an etchant of a sufficient amount required for etching to an etching portion. For example, it is said that an etching process takes from about several days to about one week at low temperatures. In such a case, when immersed in an etching solution, the vibration film of a device is damaged to reduce the yield. In order to deal with the above-described problem, there is a technique for increasing the temperature in order to achieve a high etching rate. However, there is a possibility that a soft vibration film is destroyed by bubbles generated with a high temperature etching reaction, resulting in a reduction of yield. Thus, the sacrifice layer etching in the structure of a large area and a narrow electrode gap has a fear that the productivity is kept at a low level due to diffusion control of an etching solution or the vibration film is damaged. Therefore, the realization of high-speed etching in which the possibility of damage to the vibration film is low has been desired. When the sacrifice layer etching time can be shortened, the throughput of device production increases.

On the other hand, in order to etch the sacrificial layer, it is necessary to provide an inlet for an etching solution. When the inlet for an etching solution is larger and the number thereof is larger, i.e., the exposure area of the sacrificial layer is larger, the etching rate becomes high. However, when a large hole or a large number of holes are provided as the inlet for an etching solution in the machine structure in a minute electromechanical transducer, there is a possibility that the original performance of a device is adversely affected and the design performance, life, stability, and reliability of the device are deteriorated. For example, providing a large hole or a large number of holes in the vibration film has great influence on the vibration mass, the stress of a vibration portion, the vibrational frequency, the vibration node, the vibration displacement, and the like. Therefor, it is desirable to reduce the size and the number of the inlet for an etching solution as much as possible.

### SUMMARY OF THE INVENTION

The present invention provides a method for manufacturing a capacitive electromechanical transducer having a substrate, a vibration film movably held by a support portion disposed on the substrate and has a distance from the substrate with a cavity therebetween, and two electrodes facing each other, in which, in one of the electrodes, a surface facing the cavity is exposed, and in the other one of the electrodes, a surface facing the cavity is covered with an insulation film. The method includes forming a sacrificial layer on the substrate, forming an electrode contacting the sacrificial layer, forming an etching hole for introducing an etching solution which leads to the sacrificial layer from the outside, energizing, while immersing the etching hole in an electrolytic etching solution, the electrode contacting the sacrificial layer, as one electrode, and another electrode provided at the outside and contacting the electrolytic etching solution to perform electrolytic etching of the sacrificial layer to form the cavity, and introducing a removal agent from the etching hole to reduce residue of the sacrificial layer due to the electrolytic etching.

Further features of the present invention will become apparent from the following description of exemplary embodiments with reference to the attached drawings.

### BRIEF DESCRIPTION OF THE DRAWINGS

FIGS. 1A and 1B are views illustrating an embodiment of a capacitive electromechanical transducer according to a manufacturing method of the invention.

FIGS. 2A to 2F are views illustrating a production process of an Example of the manufacturing method of the invention.

FIGS. 2G to 2K are views illustrating a production process of an Example of the manufacturing method of the invention.

FIG. 3 is a view illustrating residues of a sacrificial layer in a cavity.

FIG. 4 is a view illustrating removal of the residues of the sacrificial layer in the cavity.

FIGS. 5A to 5F are views illustrating a production process of an Example of the manufacturing method of the invention.

FIGS. 5G to 5K are views illustrating a production process of an Example of the manufacturing method of the invention.

FIG. 5L is a view illustrating the position of an etching hole.

FIGS. 6A to 6F are views illustrating a production process of an Example of the manufacturing method of the invention.

FIGS. 6G to 6K are views illustrating a production process of an Example of the manufacturing method of the invention.

### DESCRIPTION OF THE EMBODIMENTS

The features and principle of the invention will be described. According to the findings of the present inventors, the electrolytic etching allows etching of a sacrificial layer in a relatively narrow gap at a relatively high rate and bubbles are not generated in a wet etching process thereof. In the electrolytic etching, the sacrificial layer is brought into electrical contact with the anode of an electrolysis reaction in order to supply required electric charges to the sacrificial layer. Typically, a conductive metal layer having etching selectivity is disposed as the anode under the sacrificial layer, and then the electrolytic etching is performed. In this case, the etching proceeds in a sacrificial layer region contacting an anode layer but, when a sacrificial layer region that does not contact the anode is generated in the middle of the electrolytic etching, the supply of electric charges to the region is interrupted in some cases. In such a case, the electrolytic etching stops in the region, so that the sacrificial layer remains without being dissolved. The sacrificial layer residues narrow or fill the gap of the cavity, which results in a possibility that the vibration of the vibration film becomes unstable or the vibration film cannot be vibrated. Thus, the sacrificial layer residues become a cause of poor operation of a device. Furthermore, an increase in the surface roughness of the electrode or the back surface of the vibration film due to the residues becomes a cause of a reduction in device performance. In order to deal with the respect, the invention has been accomplished. The invention also includes the case of disposing a conductive metal layer having etching selectivity as the anode not under the sacrificial layer but on the sacrificial layer. In this case, there is a possibility that the sacrificial layer residues remain in a portion facing the vibration film. Also in this case, it is considered that a certain influence is exerted on the vibration of the vibration film, although the influence is not the same as that in the case where a conductive metal layer is disposed under the sacrificial layer (side facing the vibration film).

Based on the above-described findings, since etching residues sometimes remain when the cavity is formed by electrolytic etching, the manufacturing method of the invention includes introducing a sacrificial layer removal agent into the cavity to remove or reduce the sacrificial layer residues caused by the electrolytic etching. The etching solution and the sacrificial layer removal agent may be the same or different from each other. According to the view, the fundamental manufacturing method of the invention has the processes described in “SUMMARY OF THE INVENTION” above.

Typically, as described in Examples described later, an electrode in which the surface facing the cavity is exposed is used as a first electrode to be disposed on a substrate and an electrode in which the surface facing the cavity is covered with an insulation film is used as a second electrode to be disposed on the vibration film and vice versa. More specifically, the electrode whose surface facing the cavity is exposed is used as a second electrode to be disposed on the vibration film and the electrode whose surface facing the cavity is covered with an insulation film is used as a first electrode to be disposed on the substrate.

In an etching hole formation process, an etching hole can be formed on a material portion on a passage that is formed in a support portion and communicates cavities or a peripheral portion of the vibration film as described in Examples described later. The etching hole can also be formed in at least one of the material portion on the passage, the vibration film, and the substrate. When the etching hole is provided in the substrate, the etching hole is provided by, for example, deep RIE (Reactive Ion Etching) from the back surface of the substrate before removing the sacrificial layer. In such a case, for example, the substrate (e.g., Si wafer) is etched by plasma of SF₆ gas, and then the etching is completed by utilizing the insulation film (e.g., thermal oxide film) as an etch stop layer. Then, the insulation film, a lower electrode (e.g., high concentration impurity doped Si) which is the first electrode, and the like are etched to the sacrificial layer by plasma etching using gas, such as CHF₃ and CF₄. Moreover, a process for forming a sealing portion that blocks the etching hole to seal the cavity may be further carried out.

According to the manufacturing method of the invention, most of the sacrificial layer can be etched at a relatively high rate by electrolytic etching. Then, by introducing a sacrificial layer removal agent into the cavity subsequent to the electrolytic etching process, the sacrificial layer residues inside the cavity in the electrolytic etching process can be reduced. Most of the sacrificial layer inside the cavity is etched by the electrolytic etching process, so that the surface area of the sacrificial layer residues becomes large, and thus the residues can be reduced at a relatively high rate by the sacrificial layer removal agent. Thus, by a synergistic effect obtained by the combination of the electrolytic etching process and the residue removal process using the sacrificial layer removal agent, the following effects are obtained. More specifically, as compared with the case where the sacrificial layer is removed only by the sacrificial layer removal agent without using the electrolytic etching process, the sacrificial layer and the residues can be removed or reduced at a higher rate, and thus the productivity (e.g., a reduction in production time and yield) is improved. Furthermore, by providing a process for removing the residues, the surface roughness of the back surface of the vibration film and the lower electrode is reduced to increase the performance (e.g., the uniformity of performance and an increase in sensitivity) of a device.

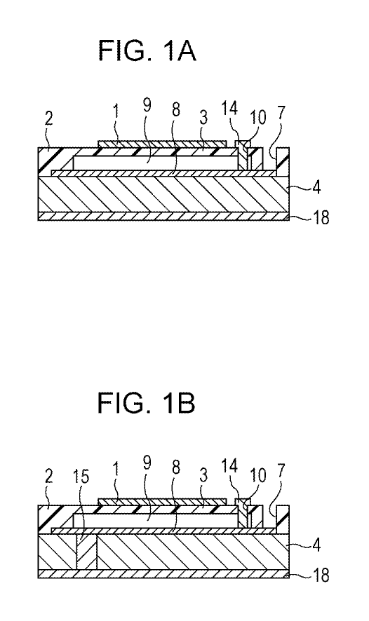

Hereinafter, embodiments of the invention will be described. In an embodiment illustrated in FIG. 1, a lower electrode 8 having a low resistance which is a first electrode is provided on a substrate 4. A support portion 2 on the lower electrode 8 is fixed to the substrate 4 and movably supports a vibration film 3 while maintaining a gap from the substrate 4. A cavity 9 is formed with being surrounded by the substrate 4, the vibration film 3, and the support portion 2. A portion of the lower electrode 8 is exposed to the cavity 9. On the upper surface of the vibration film 3, an upper electrode 1 which is a second electrode is provided and the surface facing the cavity 9 of the upper electrode 1 is covered with an insulation film (vibration film 3) and faces the lower electrode 8 therethrough. When the substrate 4 is an insulating material (e.g., glass), the upper and lower electrodes can be drawn to the back surface of the substrate 4 when a through wiring 15 is provided in the insulation substrate 4 and an electrode 18 is disposed on the substrate back surface as illustrated in FIG. 1B. The upper and lower electrodes can also be drawn out from the substrate front surface. Moreover, as described later, a sealing portion 14 that blocks an etching hole 10 is formed and a connection wiring portion (electrode pad) 7 is provided at the vibration film 3 or the support portion 2.

In usual, in order to achieve a high electromechanical conversion factor of a capacitive electromechanical transducer, it is necessary to apply a DC bias voltage between the upper electrode 1 and the lower electrode 8 during operation. Due to the action of the DC bias voltage, the electrostatic attraction pulls the upper electrode 1, so that downward displacement arises at the central portion of the vibration film 3. However, when the DC bias voltage exceeds a certain voltage once, there is a possibility that the vibration film 3 yields to contact (collapse) the lower electrode 8, and an electromechanical conversion factor decreases on the contrary. Therefore, the bias voltage is adjusted in such a manner as not to generate such a certain voltage referred to as a collapse voltage. In view of the above, when the upper electrode 1 is disposed on the lower surface of the vibration film 3, it is necessary to provide an insulation film on the lower electrode 8. In short, in order to prevent short circuit of the upper and lower electrodes, it is necessary to provide a certain insulation film between the upper and lower electrodes.

As described above, this embodiment has the following structure. Provided are the substrate, the vibration film movably supported by the support portion disposed on the substrate while maintaining a given gap from the substrate, the cavity surrounded by the substrate, the support portion, and the vibration film, the first electrode exposed to the cavity, and the second electrode facing the cavity through an insulation film. Typically, the etching hole 10 and the sealing portion 14 that seals the same are provided on the material portion on the passage that is formed at the support portion 2 and communicate the cavities. A capacitive electromechanical transducer of such a structure can be manufactured by the following manufacturing method. The lower electrode 8 is formed on the substrate 4, the sacrificial layer is formed on the first electrode, the vibration film 3 having the second electrode 1 is formed on the sacrificial layer, and the etching hole that leads to the sacrificial layer from the outside is provided in the vibration film 3 or the material portion on the passage. Then, the sacrificial layer is etched by an etching solution to form the cavity 9. Further, a sacrificial layer removal agent is introduced into the cavity to remove or reduce sacrificial layer residues generated by the etching. Thereafter, an opening as the etching hole is closed. As the etching, electrolytic etching is carried out in which the lower electrode 8 and a counter electrode provided at the outside are energized through the sacrificial layer and the etching hole. The region of the sacrificial layer is suitably completely included in the region of the first electrode to be energized. According to the findings of the present inventors, the given gap of the vibration film and the substrate is suitably 2 μm or lower and more suitably 100 nm or lower. The lower limit of the gap is not particularly limited insofar as the input-and-output values of signals are not adversely affected (also including deterioration of the electromechanical conversion factor by collapse) as the vibration film and is suitably 70 nm or more from the viewpoint of the ease of handling or manufacturing.

The capacitive electromechanical transducer constituted by an element containing two or more cells each having one cavity illustrated in FIG. 1 can be manufactured by the following manufacturing method. Electrolytic etching is performed through the first electrode, the sacrificial layer formed on the cavities of the two or more cells and the passage that communicates the cavities, and the etching hole. The electrolytic etching is performed by energizing the first electrode and an external counter electrode and etches the sacrificial layer to collectively form the two or more cavities and the passage. Herein, the region of the sacrificial layer is suitably completely included in the region of the first electrode to be energized. Then, by introducing a sacrificial layer removal agent from the etching hole subsequent to the electrolytic etching process, a process for removing or reducing the sacrificial layer is carried out.

According to the manufacturing method of this embodiment, the sacrificial layer can be etched at a relatively high rate to form the cavity 9 by the electrolytic etching process even when the size and the number of the etching hole is not increased so much also in the formation of a device having a relatively large area and thin cavity. Furthermore, by providing a process for introducing a sacrificial layer removal agent into the cavity from the etching hole subsequent to the electrolytic etching process, the sacrificial layer residues that remain in the cavity without being etched by the electrolytic etching can be reduced. Therefore, due to a synergistic effect obtained by the electrolytic etching process and the process for removing the residues by the sacrificial layer removal agent, a reduction in manufacturing time, an improvement of performance, an improvement of yield, and the like can be achieved also in a capacitive electromechanical transducer having a relatively large area and thin cavity or an array-like capacitive electromechanical transducer.

Hereinafter, specific Examples will be described with reference to the drawings but the scope of the invention is not limited to the following structure and the invention can be modified in various manners. In the description of the following Examples, the same portions as those of the above-described embodiment will be described by designating the same reference numerals as those of the above-described embodiment.

### EXAMPLE 1

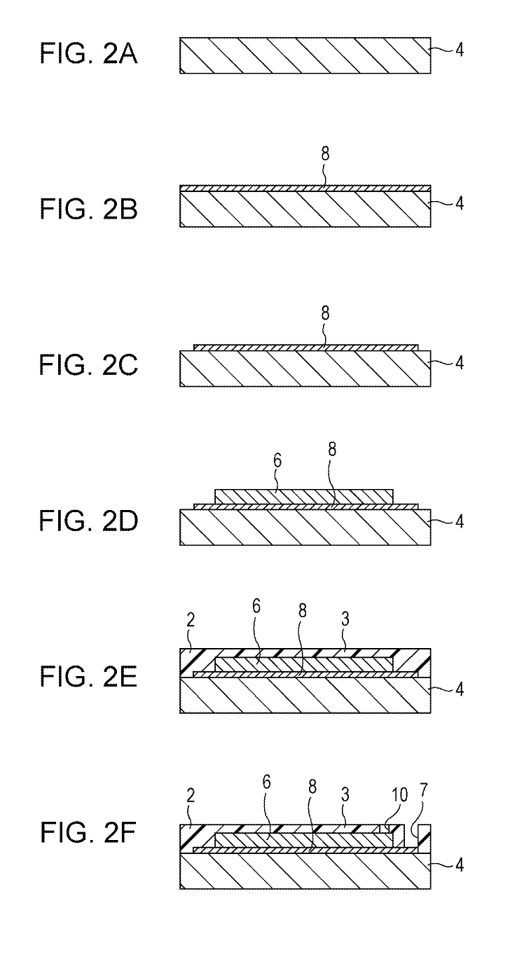

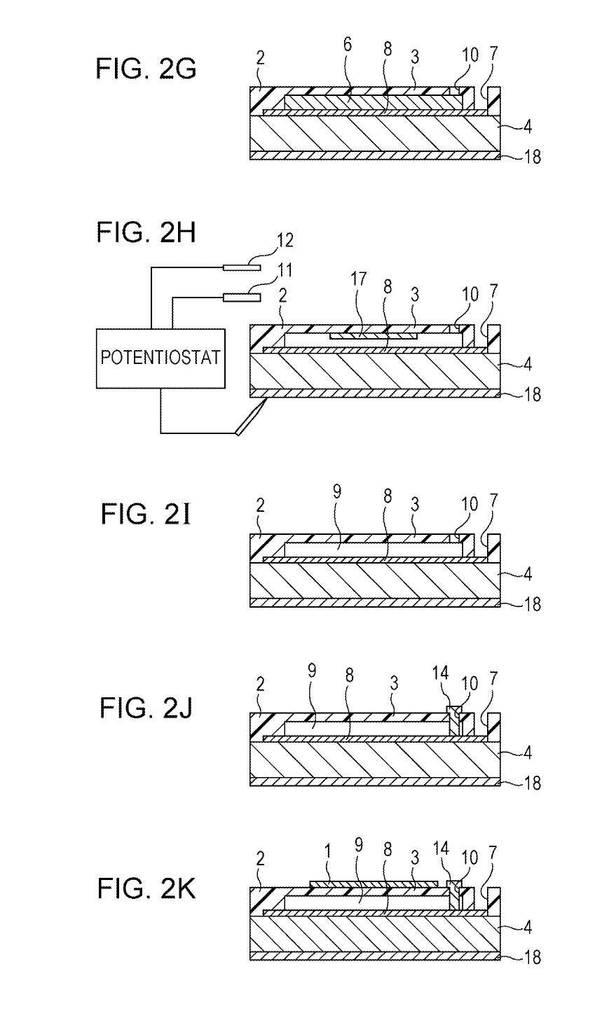

Example 1 will be described with reference to FIGS. 2A to 2K illustrating cross sectional views illustrating processes of Example 1 of a method for manufacturing a capacitive electromechanical transducer according to the invention. For brief description, it is defined that a “patterning process” refers to all the processes performed in order of a photolithography process including application, drying, exposure, development, and the like of a photoresist on a substrate, an etching process, removal of the photoresist, washing of the substrate, and a drying process. A substrate 4 of this Example will be described using a doped Si substrate as an example but a substrate of other materials can also be used. For example, substrates of SiO₂, sapphire, and the like can also be used. In this Example, since a potential is applied to a lower electrode from the back surface and electrolytic etching is performed, the substrate 4 is suitably a doped Si substrate in which impurities are doped in a Si substrate. The surface impurity concentration of this substrate is suitably 10¹⁴ cm⁻³ or more, more suitably 10¹⁶ _{cm}⁻³ or more, and still more suitably 10¹⁸ cm⁻² or more. When electrolytic etching is performed from the back surface and electrolytic etching is performed by applying a voltage directly to a lower electrode from the front surface, a Si substrate in which impurities are not doped is acceptable.

In the manufacturing method of this Example, first, a Si substrate 4 is prepared as illustrated in FIG. 2A and then washed. Next, as illustrated in FIG. 2B, a Ti layer to be used as a lower electrode 8 is formed by sputtering on the surface of the Si substrate 4. In the following process, in order to perform uniform, stable, and high-rate etching in electrolytic etching of a sacrificial layer, it is suitable to reduce voltage drop by the lower electrode 8. Next, as illustrated in FIG. 2C, the lower electrode 8 (Ti film) is patterned using a solution containing hydrofluoric acid or the like. Next, as illustrated in FIG. 2D, a sacrificial layer 6 is formed and patterned. In order to etch the sacrificial layer 6 uniformly, stably, and at high rate in the following electrolytic etching process, it is suitable to reduce voltage drop in the sacrificial layer 6. Therefore, metal may be utilized for the material of the sacrificial layer 6. In this Example, a Cr film formed by an EB (Electron Beam) vapor deposition method is used as the material of the sacrificial layer 6. The Cr film can be patterned using a solution containing diammonium cerium nitrate or the like. Next, a vibration film 3 is formed as illustrated in FIG. 2E. For the material of the vibration film 3, a Si₃N₄ film or the like can be used that is formed by a PECVD (Plasma Enhanced Chemical Vapor Deposition) method. In this process, a vibration film support portion 2 is also simultaneously formed.

Next, as illustrated in FIG. 2F, the Si₃N₄ film of the vibration film 3 is patterned by a plasma dry etching method with CF₄ gas or the like to form an etching hole 10 for introducing an etching solution that leads to the sacrificial layer 6 from the outside. The hole 10 that is an inlet of the etching solution can be formed by a dry etching method with CF₄ gas plasma while using the sacrificial layer 6 as an etching stop layer. The dry etching with CF₄ gas plasma allows precise etching. Therefore, an electrode pad 7 that is an electrode drawing-out port of the lower electrode 8 can be simultaneously formed in this process without severely damaging the lower electrode 8.

Next, as illustrated in FIG. 2G, in order to reduce contact resistance with the back surface of the substrate 4, it is suitable to provide a single-layer metal back surface electrode 18, e.g., Ti, (film thickness of 20 nm to 1000 nm) on the back surface of the substrate 4. Next, as illustrated in FIG. 2H, electrolytic etching is carried out by applying a voltage to the lower electrode (one electrode for electrolytic etching) 8 from the substrate back surface in a state where the etching hole is immersed in an electrolytic etching solution. In the process, a counter electrode 12 which is the other electrode for electrolytic etching and a reference electrode 11 are disposed. For the electrolytic etching solution in this process, a salt solution with a concentration of 2 mol/l can be utilized, for example. Thus, by applying a voltage to the lower electrode 8 and supplying holes to the sacrificial layer 6 in the state where the etching hole is immersed in the electrolytic etching solution, electrolytic etching is initiated from the hole 10 to be used as the inlet of the etching solution, so that the sacrificial layer 6 can be etched in a relatively short time. The electrolytic solution is not limited to the salt solution (NaCl liquid) and other electrolytic solutions, e.g., a substance containing KCl or the like and having a sufficiently low dissolution rate to constituent materials other than the sacrificial layer, can also be used.

With respect to the voltage applied to the electrolytic etching in this process, the electrolytic etching is carried out at a voltage higher than the dissolution voltage of the sacrificial layer 6 and lower than the dissolution voltage of the lower electrode 8. More specifically, when Cr is used as the material of the sacrificial layer 6 and Ti is used as the material of the lower electrode 8, the electrolysis voltage is set to be higher than the dissolution voltage, 0.75 V, of Cr of the sacrificial layer 6 and equal to or lower than the dissolution voltage, 4 V, of Ti of the lower electrode 8. For example, when electrolytic etching is carried out using a device in which a large number of 40 μm sacrificial layer Cr patterns (film thickness of 200 nm) are disposed in a 19 mm square chip, an applied voltage is set to about 2.7 V. As a result, the current value was asymptotic to 0 in about 240 seconds and the results of observation under an optical microscope revealed that etching of the sacrificial layer by electrolytic etching was completed.

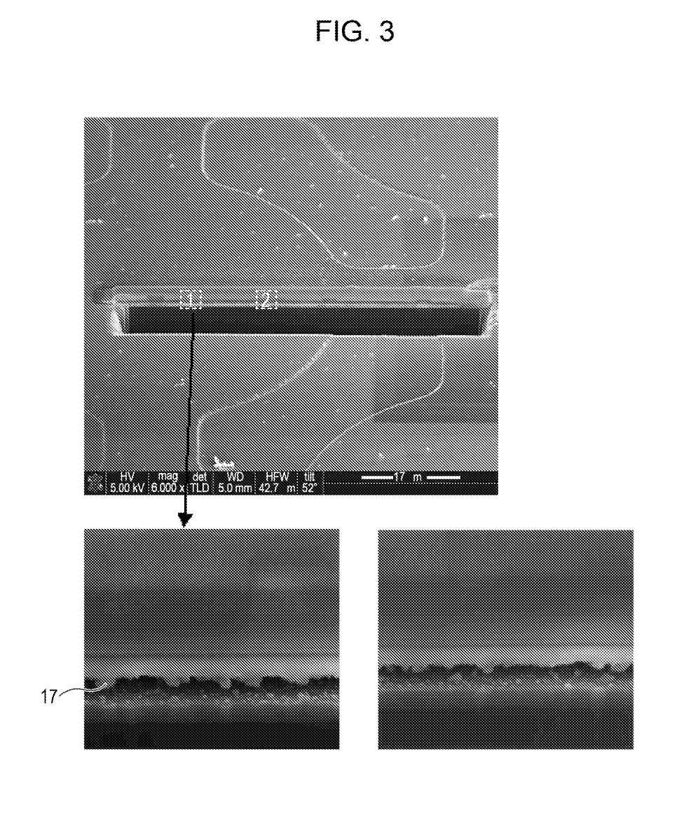

However, only by the electrolytic etching, even when the selection of the materials of the sacrificial layer 6 and the lower electrode 8, the applied voltage, and application time are appropriately set, residues 17 of the sacrificial layer sometimes remains in the cavity 9. FIG. 3 is a photograph showing the results obtained by observing, under SEM (Scanning Electron Microscopy), the cross sectional shape of the cavity 9 that is opened by FIB (Focus Ion Beam) after performing a washing process and a drying process after the electrolytic etching. A large number of icicle-like substances remain in the cavity 9 to block the inside of the cavity 9. The results of analyzing the element ingredients constituting the inside of the cavity 9 by EDS (Energy Dispersive Spectroscopy) showed that Cr, which is a sacrificial layer, remained in the cavity 9 as the residues 17.

Next, subsequent to the electrolytic etching process, after the etching hole is immersed in pure water and sufficiently washed, the etching hole is immersed in a sacrificial layer removal agent illustrated in FIG. 21. Thus, a sacrificial layer removal agent is introduced into the cavity 9 from the hole 10, so that the residues 17 of the sacrificial layer remaining in the cavity 9 due to the electrolytic etching can be removed. For the sacrificial layer removal agent, a substance can be used that dissolves the sacrificial layer and has a sufficiently lower dissolution rate to other constituent materials than the dissolution rate of the sacrificial layer. For example, when Ti is used for the lower electrode 8, Cr is used for the sacrificial layer 6, and Si₃N₄ is used for the vibration film 3, a solution containing diammonium cerium nitrate or the like can be used for the sacrificial layer removal agent. By immersing the etching hole in pure water and washing the same after the electrolytic etching, the inside of the cavity 9 is filled with pure water. Therefore, when immersed in the sacrificial layer removal agent while maintaining the state, diffusion of the solution due to a concentration gradient occurs between the pure water and the sacrificial layer removal agent, so that the sacrificial layer removal agent can be relatively easily introduced also in the large area and thin cavity 9, whereby the residues 17 of the sacrificial layer can be removed.

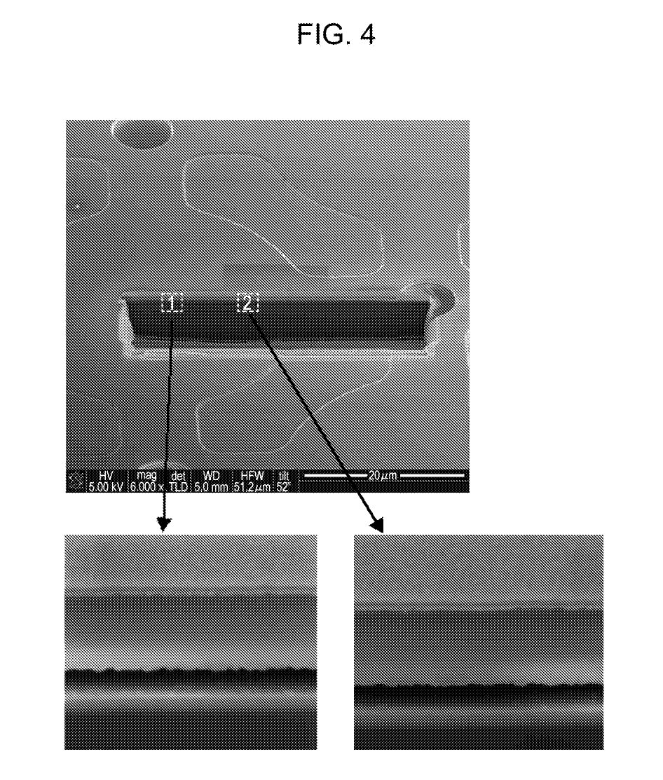

FIG. 4 is a photograph obtained by observing, under SEM, the cross sectional shape of the cavity 9 that is opened by FIB after performing the processes of immersing in the sacrificial layer removal agent, washing, and drying. It is revealed that the residues 17 of the sacrificial layer remaining after the electrolytic etching are reduced by the sacrificial layer removal agent and the cavity 9 is effectively formed. The results of analyzing the element ingredients constituting the inside of the cavity 9 by EDS showed that Cr, which is the ingredients of the sacrificial layer, was almost removed from the inside of the cavity 9 by the sacrificial layer removal process.

Furthermore, Table 1 below shows the AFM (Atomic Force Microscope) measurement results of the floor portion (i.e., lower electrode surface) and the ceiling portion (i.e., vibration film back surface) inside the cavity 9 in the case of only the electrolytic etching and the case of combining the electrolytic etching and the immersion in the sacrificial layer removal agent. By the sacrificial layer removal agent immersion process, the residues 17 of the sacrificial layer inside the cavity 9 are reduced, and the surface roughness of the floor (lower electrode surface) and the ceiling (vibration film back surface) is reduced as compared with that before the immersion. More specifically, it was confirmed that the surface roughness was reduced by about ⅕, i.e., a reduction from about 12 nm to about 2.5 nm at the floor and a reduction from about 9.2 nm to about 1.9 nm at the ceiling.

TABLE 1

| | | | | Roughness |
|---|---|---|---|---|
| Sacrificial | Measurement | Cr etchant | | reduction |
| layer | portion | immersion | Rms (nm) | ratio |
| Cr | Ceiling | None | 9.2 | About 1/5 |
| 200 nm | | Done | 1.9 | reduction |
| | Floor | None | 12.0 | About 1/5 |
| | | Done | 2.5 | reduction |

After the completion of the process for removing the sacrificial layer residues, the etching hole is washed with pure water and dried. Next, as illustrated in FIG. 2J, Al or the like is formed into a film by EB vapor deposition to seal the hole 10, and then patterning is performed to form a sealing portion 14. In the sealing process, at least one of a nitride film, an oxide film, a nitride oxide film, a polymer resin film, and a metal film by CVD, PVD, or the like can be selected. Next, as illustrated in FIG. 2K, the upper electrode 1 is formed on the surface of the vibration film 3 and then patterned. In this Example, metal, such as Al, by EB vapor deposition can be used as the material of the upper electrode 1.

As described above, according to the method for manufacturing a capacitive electromechanical transducer in this Example, the residues in the cavity 9 that pose a problem in the device manufactured only using the electrolytic etching can be reduced. Moreover, a method for manufacturing a capacitive electromechanical transducer in which the productivity that becomes a problem when manufacturing only by immersion in a sacrificial layer removal agent can be provided.

### EXAMPLE 2

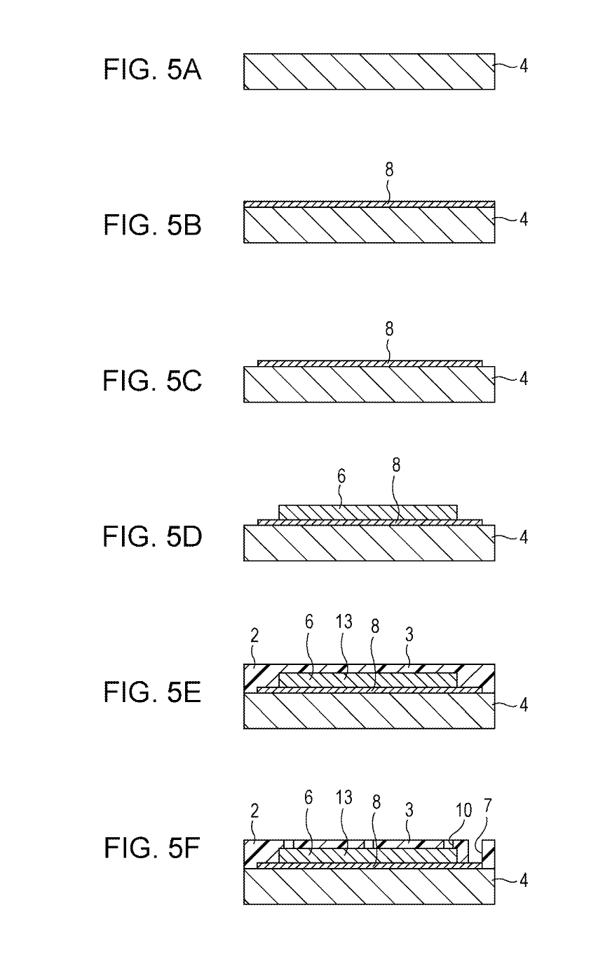

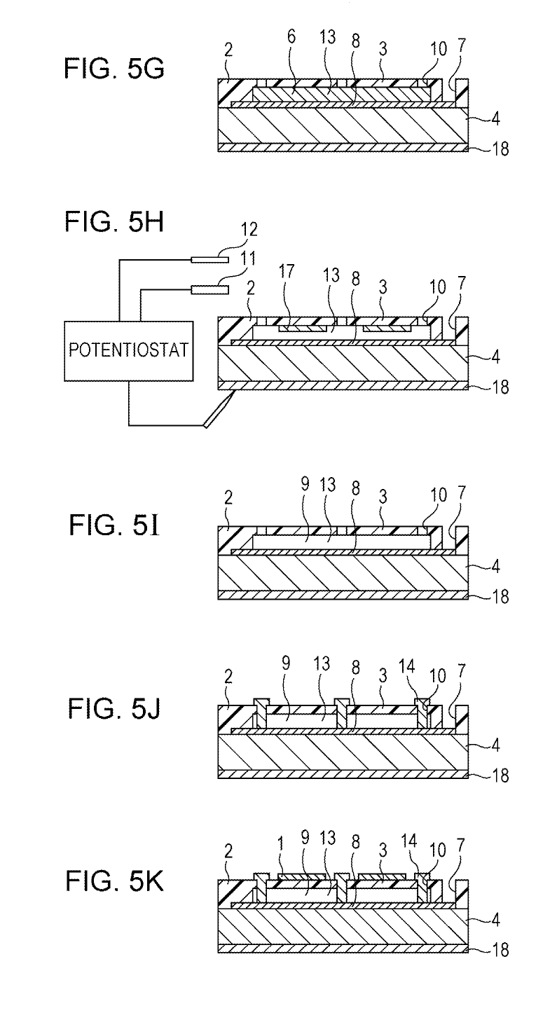

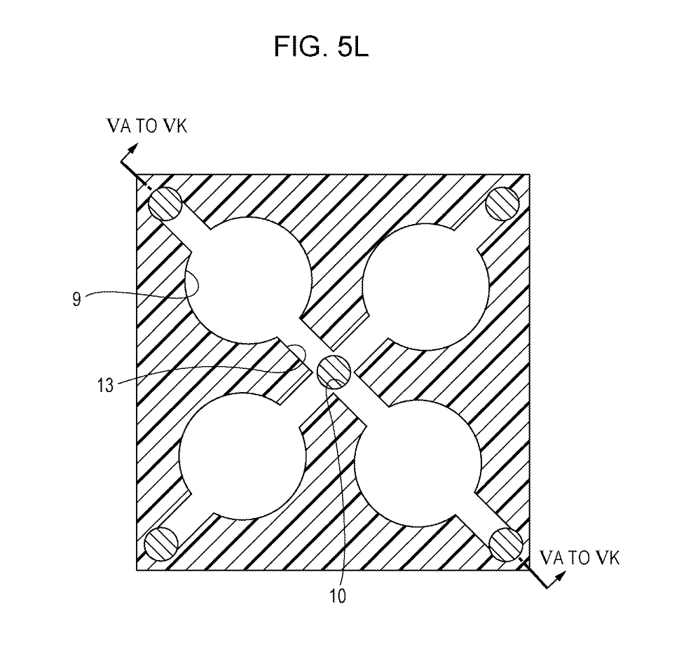

FIGS. 5A to 5K and FIG. 5L are cross sectional views illustrating Example 2 of the method for manufacturing a capacitive electromechanical transducer according to the invention. FIGS. 5A to 5k are views illustrating processes and the views are cross sectional views along the VA to VK line of FIG. 5L. The processes illustrated in 5A to 5K are almost the same as those of Example 1. Particularly in the capacitive electromechanical transducer in this Example, two or more cavities 9 are connected to each other by flow paths 13 and, as illustrated in FIG. 5L, an etching hole 10 is provide at the intersection of the flow paths 13 connecting the two or more cavities 9. The flow paths 13 can be collectively formed with portions of the cavities 9 in the sacrificial layer formation process for forming the cavities 9. In this Example, in the electrolytic etching process and the process for removing the residues of the sacrificial layer, an etching reaction proceeds from the two or more holes 10 to one cavity 9 in the electrolytic etching process. Therefore, as compared with the case of Example 1, electrolytic etching can be completed at a higher rate. Also in the process for removing the residues 17 of the sacrificial layer, since a sacrificial layer removal agent is introduced from the two or more holes 10, the sacrificial layer removal agent is diffused in the cavities 9 at a higher rate and the residues 17 can be reduced at a higher rate as compared with the case of Example 1. As described above, according to the method for manufacturing a capacitive electromechanical transducer of this Example, a capacitive electromechanical transducer can be provided in which the residues of the sacrificial layer inside the cavities 9 are reduced at a higher rate.

### EXAMPLE 3

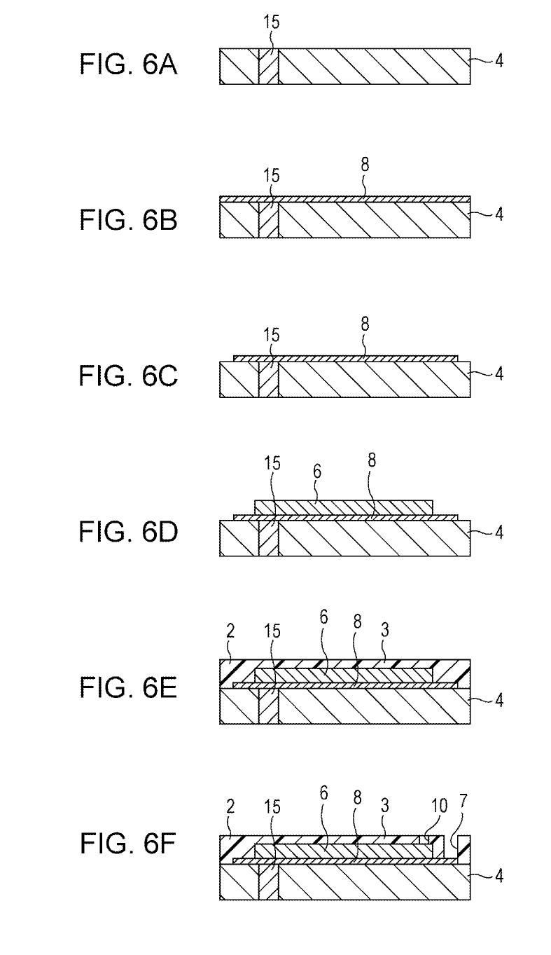

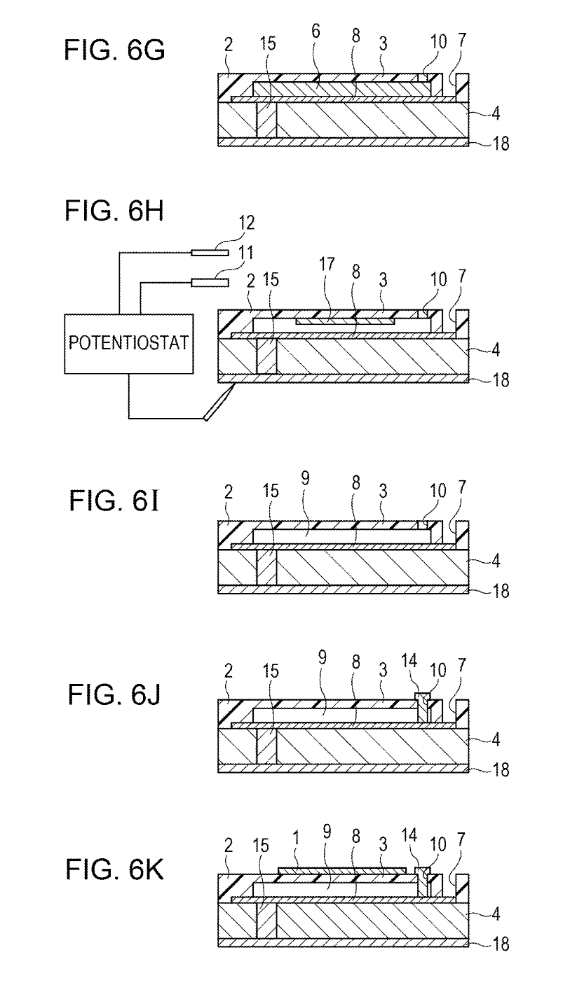

FIGS. 6A to FIG. 6K are cross sectional views illustrating Example 3 of a method for manufacturing a capacitive electromechanical transducer according to the invention. The capacitive electromechanical transducer in this Example is almost the same as that of Examples 1 and 2 but employs an insulation substrate 4 having a through wiring 15 for the inside of the substrate. As such an insulation substrate having the through wiring 15, a commercially available item can also be used. For example, the substrate can be produced by utilizing a photosensitive glass (PEG3C, manufactured by Hoya Corp.) and by opening a through hole in the substrate, filling the inside of the opening hole with metal, such as Cu, and then CMP (Chemical Mechanical Polishing) polishing the substrate surface. In this Example, the description will be given taking the glass substrate as an example.

The processes illustrated in FIGS. 6A to 6H are the same as those of Examples 1 and 2. Next, as illustrated in FIG. 6I, a process for immersing the etching hole in a sacrificial layer removal agent to reduce residues remaining in the cavity 9 in the electrolytic etching is carried out. In this process, for the sacrificial layer removal agent, a material may be used that dissolves the sacrificial layer 6 and has a sufficiently lower dissolution rate to the substrate 5, the lower electrode 8, the vibration film 3, and the through wiring 15 than the dissolution rate of the sacrificial layer. The through wiring 15 may be immersed in a sacrificial layer removal agent in a state of protecting the substrate back surface with a material having a sufficiently lower dissolution rate than the dissolution rate of the sacrificial layer, and the selectivity to the through wiring 15 of the sacrificial layer removal agent is not necessarily required. As the material for protecting the substrate back surface, there is a method for covering the same with a Ti film or a resist film. Moreover, a back surface electrode 18 that is formed on the back surface in the process for FIG. 6G may also be used for the purpose. Moreover, a method for mechanically covering the substrate back surface by a jig or the like, in such a manner that the substrate back surface does not physically contact the sacrificial layer removal agent is also effective. The other processes are the same as those of Examples 1 and 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-134162 filed Jun. 11, 2010, which is hereby incorporated by reference herein in its entirety.

What is claimed is:

1. A method for manufacturing a capacitive electromechanical transducer having a substrate, a vibration film that is movably hold by a support portion disposed on the substrate and has a given distance from the substrate with a cavity therebetween, and two electrodes facing each other, in which, in one of the electrodes, a surface facing the cavity is exposed and, in the other one of the electrodes, a surface facing the cavity is covered with an insulation film, the method comprising:
forming a sacrificial layer on the substrate,
forming an electrode contacting the sacrificial layer,
forming a layer containing the vibration film on the sacrificial layer,
forming an etching hole for introducing an etching solution that leads to the sacrificial layer from outside,
energizing, while immersing the etching hole in an electrolytic etching solution, the electrode contacting the sacrificial layer, as one electrode, and another electrode provided at the outside and contacting the electrolytic etching solution to perform electrolytic etching of the sacrificial layer to form the cavity, and
introducing a removal agent from the etching hole to reduce a residue of the sacrificial layer due to the electrolytic etching.

2. The method according to claim 1, wherein the sacrificial layer includes a material that is dissolved by the removal agent and the electrode in which the surface facing the cavity is exposed and the vibration film includes a material having a dissolution rate lower than that of the sacrificial layer.

3. The method according to claim 1, further comprising forming a sealing portion that blocks two or more etching holes to sealing the cavity.

4. The method according to claim 1, wherein, the etching hole is formed in at least one of a material portion on a passage that is formed in the support portion and communicates the cavities, the vibration film, and the substrate.

5. The method for manufacturing a capacitive electromechanical transducer according to claim 1, wherein the electrode in which the surface facing the cavity is exposed is a first electrode provided on the substrate and the electrode in which the surface facing the cavity is covered with an insulation film is a second electrode provided on the vibration film.

6. The method according to claim 5, wherein the sacrificial layer includes a material that is dissolved by the removal agent and the electrode in which the surface facing the cavity is exposed and the vibration film includes a material having a dissolution rate lower than that of the sacrificial layer.

7. The method according to claim 5, further comprising forming a sealing portion that blocks two or more etching holes to sealing the cavity.

8. The method according to claim 5, wherein, the etching hole is formed in at least one of a material portion on a passage that is formed in the support portion and communicates the cavities, the vibration film, and the substrate.
